(19) United States
(12) Patent Application Publication
(10) Pub. No.: US 2003/0043431 A1
(43) Pub. Date: Mar. 6, 2003

(54) Simultaneous demultiplexing and clock recovery of high-speed OTDM signals using a tandem electro-absorption modulator

(76) Inventors: Naresh Chand, Warren, NJ (US); Keisuke Kojima, Bridgewater, NJ (US); Thomas Gordon Beck Mason, Bethlehem, PA (US); Jianjun Yu, Murray Hill, NJ (US); Rolando Espindola, Basking Ridge, NJ (US)

Correspondence Address: CHRISTIE, PARKER & HALE, LLP, 350 WEST COLORADO BOULEVARD, SUITE 500, PASADENA, CA, 91105, US

(21) Appl. No.: 10/060,688

(22) Filed: Jan. 30, 2002

Related U.S. Application Data
(60) Provisional application No. 60/316,671, filed on Aug. 30, 2001.
(60) Provisional application No. 60/322,018, filed on Sep. 11, 2001.

(51) Int. Cl. H04J 14/08; H04B 10/06

(52) U.S. Cl. 359/135; 359/189

(57) ABSTRACT

Simultaneous demultiplexing and clock recovery of high-speed (e.g., 80 Gbps or 160 Gbps) optical time division multiplexing (OTDM) signals is achieved using a tandem electro-absorption modulator (TEAM). The TEAM has a monolithically integrated SOA to compensate the insertion loss and two EAMs to reduce the switching window. The demultiplexing and clock recovery may be performed by a single TEAM, or by two or more TEAMs. A fiber Raman amplifier may be used to boost the intensity of the OTDM signals during transmission.

### CROSS-REFERENCE TO RELATED APPLICATION(S)

This application claims priority of U.S. Provisional Patent Application No. 60/316,671 entitled “Simultaneous Demultiplexing and Clock Recovery of High-Speed OTDM Signals Using a Tandem Electro-Absorption Modulator” filed on Aug. 30, 2001 and U.S. Provisional Patent Application No. 60/322,018 entitled “160 Gb/s Single-Channel Transmission over 200 KM of Nonzero-Dispersion Fiber with Fiber Raman Amplifier and a TEAM Simultaneous Demultiplexing and Clock Recovery” filed on Sep. 11, 2001, the contents of both of which are hereby incorporated by reference.

### FIELD OF THE INVENTION

The present invention is related to optical communication systems, and more particularly to simultaneous demultiplexing and clock recovery of high-speed OTDM signals using one or more tandem electro-absorption modulators (TEAMs).

### BACKGROUND OF THE INVENTION

Semiconductor based electro-absorption modulators (EAMs) are often considered for applications in high-speed optical communication systems due to their low driving voltage, high modulation efficiency, polarization insensitivity and integrability with lasers or SOAs. Thus, various different high-speed optical time division multiplexing (OTDM) experiments have been conducted to demonstrate generation of return-to-zero signal, demultiplexing or clock recovery using EAMs. In particular, EAMs have been considered for applications in all-OTDM signals, which is a key technique in future optical communications.

However, EAMs typically have a relatively large insertion loss of larger than 10 dB, and use of EAM-based optical receiver may result in significant loss of signal intensity during demultiplexing. In addition, the switching window of EAMs at low drive voltage is typically larger than 10 ps, and cascaded EAMs may be required to demultiplex high-speed (e.g., 80 Gbps or higher speed) OTDM signals. Due to their relatively large insertion loss, use of cascaded EAMs may result in further loss of signal intensity.

In conventional optical receivers, clock recovery and demultiplexing of the OTDM signals are typically performed by separate circuitry.

J. D. Phillips et al. in “Simultaneous Demultiplexing and Clock Recovery Using a Single Electroabsorption Modulator in a Novel Bi-Directional Configuration” Optical Communications 150, pp. 101-105 (1998) suggest using a single electro-absorption modulator for simultaneous demultiplexing and clock recovery; however, the system suggested by Phillips et al. requires a use of complex circuitry to generate bi-directional signals from the OTDM signals. Further, the system suggested by Phillips et al., which uses a single EAM, appears to be suitable only for demultiplexing 40 Gbps or slower speed OTDM signals, for example, due to its large switching window (e.g., larger than 10 pico seconds (ps)).

### SUMMARY

In an exemplary embodiment according to the present invention, an optical receiver comprising a single integrated device capable of substantially simultaneously performing demultiplexing and clock recovery of an OTDM signal having a speed higher than 40 Gbps is provided.

In another exemplary embodiment according to the present invention, an optical receiver for substantially simultaneously demultiplexing an OTDM signal and recovering clock from the OTDM signal is provided. The optical receiver comprises a first TEAM for demultiplexing the OTDM signal and a second TEAM for recovering clock from the OTDM signal.

In yet another exemplary embodiment according to the present invention, an optical communication system comprising a transmitter, a transmission medium and a receiver is provided. The transmitter is used for generating and transmitting an OTDM signal, and the transmission medium is suitable for carrying the OTDM signal. The receiver used for receiving the OTDM signal comprises one or more TEAMs. The receiver is capable of substantially simultaneously performing demultiplexing and clock recovery of the OTDM signal using said one or more TEAMs.

### BRIEF DESCRIPTION OF THE DRAWINGS

These and other aspects of the invention may be understood by reference to the following detailed description, taken in conjunction with the accompanying drawings, which are briefly described below.

FIG. 1 is a block diagram of an optical communication system, which may be used to implement an exemplary embodiment according to the present invention;

FIG. 2 is a block diagram of an optical receiver in an exemplary embodiment according to the present invention;

FIGS. 3(a) and 3(b) illustrate relative intensity characteristics of electro-absorption modulators (EAMs) in an exemplary embodiment according to the present invention;

FIGS. 4(a) and 4(b) illustrate auto-correlator traces for a tandem electro-absorption modulator (TEAM) in an exemplary embodiment according to the present invention.

FIG. 5 illustrates BER performance, waveform and eye diagrams measured for an optical communication system in an exemplary embodiment according to the present invention;

FIG. 6 illustrates BER performance, waveform and eye diagrams measured for an optical communication system in an exemplary embodiment according to the present invention;

FIG. 7 is a block diagram of an optical communication system, which may be used to implement an exemplary embodiment according to the present invention;

FIGS. 8(a) and 8(b) illustrate, respectively, auto-correlator traces and an optical spectrum in an exemplary embodiment according to the present invention;

FIGS. 9(a) and 9(b) illustrate, respectively, an eye diagram and an auto-correlator trace for an OTDM signal in an exemplary embodiment according to the present invention; and

FIG. 10 illustrates BER performance, waveform and eye diagrams measured for an optical communication system in an exemplary embodiment according to the present invention.

### DETAILED DESCRIPTION

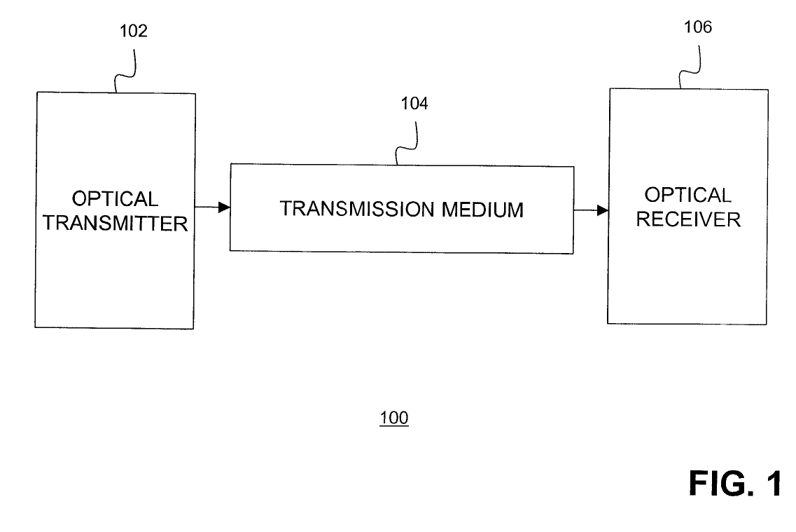

FIG. 1 illustrates an optical communication system 100, which may be used to implement an exemplary embodiment according to the present invention. In the optical communication system 100, an optical transmitter 102 may transmit a multiplexed optical signal (e.g., optical time division multiplexed (OTDM) signal) over a transmission medium 104 to an optical receiver 106. The optical receiver 106 should be capable of demultiplexing the multiplexed signal as well as recovering the clock from the multiplexed signal.

For example, the optical transmitter may include a 1548.6 nano meter (nm) distributed feedback (DFB) laser. The optical signal may be provided to an electro-absorption modulator (EAM), which may be driven with a 20 GHz sinusoidal RF tone. Thus driven, the EAM may provide a 20 GHz train of approximately 13 pico second (ps) pulses in response to the 1548.6 nm DFB laser input.

The train of pulses may then be amplified by an erbium-doped fiber amplifier (EDFA) to boost their intensity. Thereafter, the amplified pulses may be modulated by a 20 Gbps (Giga bits per second) data stream in a modulator (e.g., LiNbO₃ modulator). The 20 Gbps data stream, for example, may be generated by electrically multiplexing two 10 Gbps data streams. In other embodiments, the data stream used for modulating optical pulses may have different data rates (e.g., 10 Gbps, 30 Gbps, 40 Gbps, 80 Gbps or 160 Gbps), and may be generated as a single data stream or through multiplexing different number of data streams.

The modulated optical signals may be compressed and regenerated by multiple (e.g., two) fiber stages, each of which may comprise one or more of, but is not limited to, a dispersion shifted fiber (DSF), a tunable optical filter (TOF), and a single mode fiber (SMF). For example, after the first fiber stage, the pulse width may be 8 ps, and after the second fiber stage, it may be 4 ps. Of course, the pulse widths may be different in other embodiments, and may depend on the requirements of particular applications. The compressed and regenerated signal may then be multiplexed by a multi-stage (e.g., two or three) fiber delay-line multiplexer to generate a high-speed (e.g., 80 Gbps, 160 Gbps, or higher data rate) OTDM signal.

The transmission medium 104 may include one or more EDFAs, dispersion compensation fibers (DCFs) and dispersion shifted fibers (DSFs). The DSFs, for example, may comprise True-Wave® Nonzero-Dispersion (TW) fibers available from Lucent Technologies, Inc., Murray Hill, N.J.

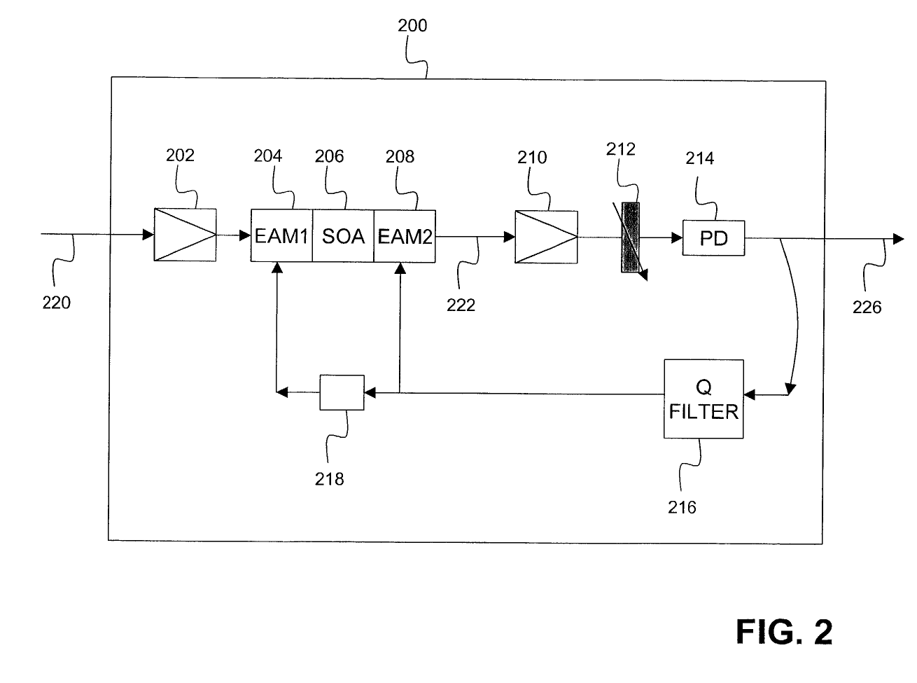

FIG. 2 is a block diagram of an optical receiver 200, which may represent a more detailed illustration of the optical receiver 106 of FIG. 1 in the exemplary embodiment. In the optical receiver 200 of FIG. 2, clock recovery and demultiplexing may be realized simultaneously in a tandem electro-absorption modulator (TEAM). In other embodiments, multiple TEAMs may be used for simultaneous demultiplexing and clock recovery, in which for example, at least one TEAM is used for demultiplexing and at least one other TEAM is used for clock recovery.

To compensate the insertion loss, the EAMs of the TEAM may be monolithically integrated with a semiconductor optical amplifier (SOA). Thus in the exemplary embodiment, the TEAM comprises a semiconductor optical amplifier (SOA) 206 interposed between two electro-absorption modulators 204 and 208. When a high-speed OTDM is being demultiplexed, a narrow switching window is typically required. For example, the TEAM may be suitable for demultiplexing 40 Gbps, 80 Gbps or 160 Gbps OTDM signals, and may have a switching window smaller than 10 ps and a total insertion loss of approximately 0 dB for the tandem, or even a total insertion gain.

The EAMs and the SOA may have a thin separate confinement heterostructure multi-quantum well active layer or any other suitable structure. The device may be fabricated using a deep ridge buried heterostructure process or any other suitable process known to those skilled in the art. Spot size converters (SSC) may be used on the input and/or output waveguides to improve the optical coupling efficiency.

When an OTDM signal 220 is received over a transmission medium, such as the transmission medium 104 of FIG. 1, an EDFA 202 first receives the OTDM signal 220 to boost its intensity. The boosted OTDM signal is provided to the TEAM comprised of the EAMs 204, 208, and the SOA 206 interposed between the two EAMs. For example, in an exemplary embodiment, the first EAM may demultiplex the 160 Gbps OTDM signal to 40 Gbps signals, and the second EAM may demultiplex the 40 Gbps signals to 10 Gbps signals. In other embodiments, the first EAM may demultiplex the 80 Gbps OTDM signal to 40 or 20 Gbps signals.

The demultiplexed signal may then be boosted by an EDFA 210, and then applied to a tunable optical filter 212, which for example, may be used to suppress the accumulated amplified spontaneous emission (ASE) noise of EDFAs and SOA, and to improve the receiver sensitivity. The filtered optical signal may then be applied to a photodiode 214 to be converted to an electrical signal 226. The sensitivity of the optical receiver may be adjusted, for example, by adjusting the sensitivity of the photodiode 214.

Clock recovery may also be achieved by using an injection locked electro-optic oscillator comprised of TEAM, a high gain loop and a high Q filter 216. The electrical signal 226 may be applied to the Q filter 216, and the output of the Q filter 216 may be provided to the second EAM 208. A frequency adjuster 218 may be placed between the Q filter output 216 and the first EAM 204 to provide different clock frequency to the first EAM 204. For example, the frequency adjuster 218 may double or quadruple the frequency applied to the first EAM 204 over that applied to the second EAM 208 depending on the required data rate at the output of each EAM.

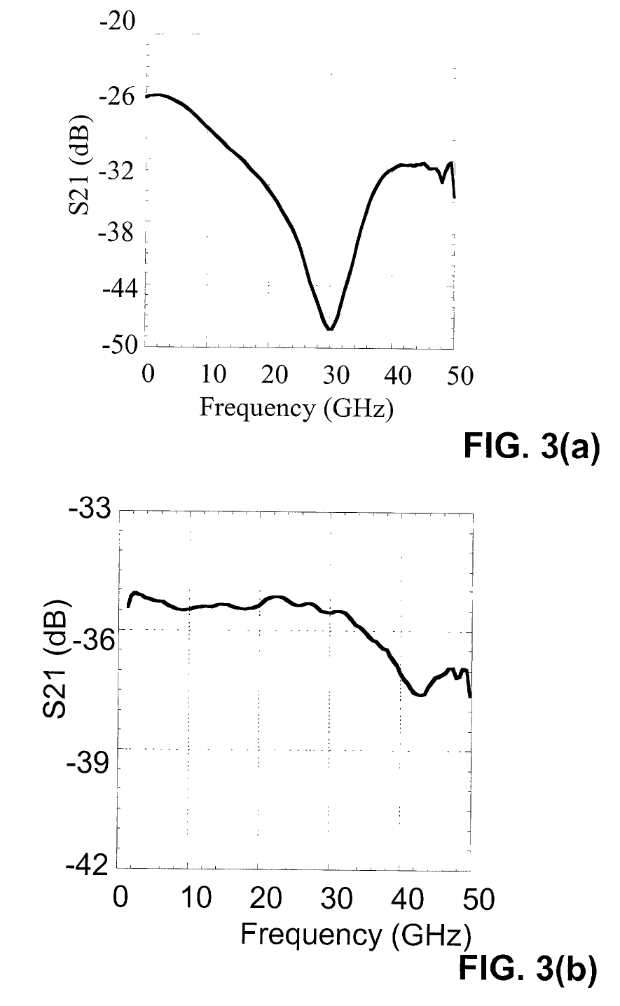

FIGS. 3(a) and 3(b) illustrate relative intensity characteristics of EAMs 204 and 208, respectively, of an exemplary embodiment. It can be seen in FIGS. 3(a) and 3(b) that the first EAM 204 is a narrow band modulator and the second EAM 208 is a broadband modulator. For example, the TEAM represented by the FIGS. 3(a) and 3(b) may be suitable for generating a 40 Gbps return-to-zero (RZ) signal. The fiber-to-fiber gain at 130 mA SOA bias may be approximately 8.8 dB. The 3 dB bandwidth of the EAMs, the SOA bias and/or the fiber-to-fiber gain of the SOA may be different in other embodiments. Further, in other embodiments, both EAMs each may comprise a narrow band modulator, such as, for example, the one with characteristics illustrated in FIG. 3(a).

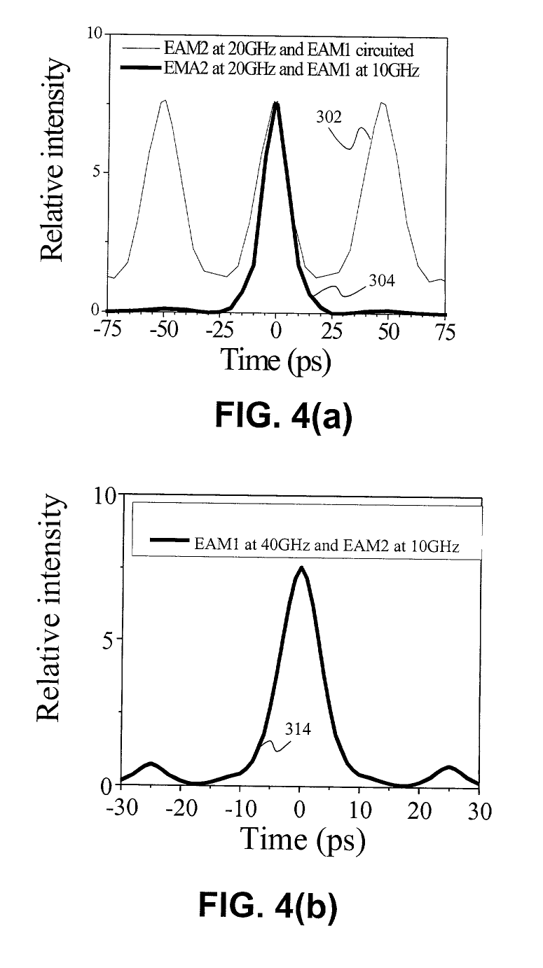

In an exemplary embodiment, an auto-correlator may be used to measure the switching window of the TEAM. FIGS. 4(a) and 4(b) illustrate typical auto-correlator traces. FIG. 4(a) illustrates an auto-correlator trace 302 generated when the first EAM 204 is short-circuited and the second EAM 208 is driven by 20 GHz sinusoidal wave with 3 Vₚₚ (peak-to-peak voltage) drive voltage. Since the second EAM 208 is a broadband modulator in this embodiment, the ER of the generated pulse may not be very high.

FIG. 4(a) also illustrates an auto-correlator trace 304 generated when the first EAM 204 is driven by a 10 GHz, 3 Vpp sinusoidal wave, and the second EAM 208 is simultaneously driven by a 20 GHz, 3 Vpp sinusoidal wave. In this case, the switching window of TEAM is approximately 9 ps (FWHM (full width at half maximum)). This switching window may be narrow enough for demultiplexing an 80 Gbps OTDM signal. It can be seen that there is a small peak at ±50 ps although the ER at ±25 ps is larger than 30 dB. This may lead to some crosstalk from the adjacent channels when OTDM signals are demultiplexed.

FIG. 4(b) illustrates an auto-correlator trace when one of the EAMs is driven by 40 GHz and the other EAM is driven at 10 GHz. When the first EAM 204 is driven by 40 GHz, which case is illustrated by the trace 314, there is a high ER and narrow switching window at 40 GHz. However, when the pulse propagating through the second EAM 208 is driven at 10 GHz, the adjacent pulse may not be suppressed completely because the second EAM 208 is a broadband modulator. There is a small peak at ±25 ps although the ER at ±12.5 ps is larger than 30 dB. In this case the switching window is approximately 5.5 ps, which may be narrow enough for demultiplexing a 160 Gbps OTDM signal.

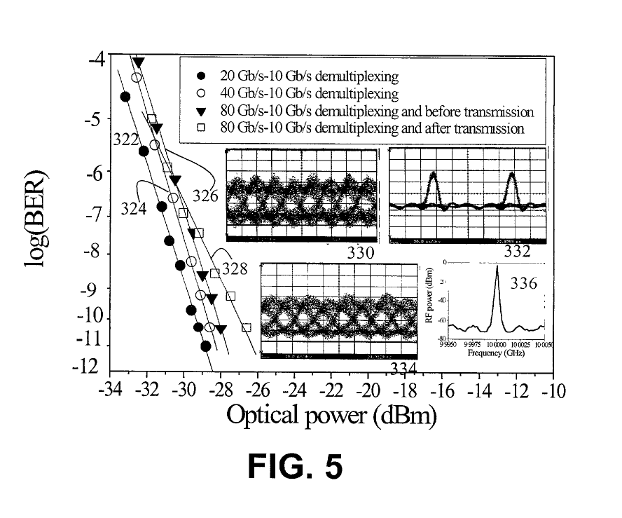

FIG. 5 shows BER performance, waveform and typical eye diagrams measured with a 50 GHz photodiode and a 50 GHz sampling oscilloscope. A diagram 330 is the 80 Gbps OTDM eye diagram before transmission, while a diagram 332 shows the demultiplexed eye diagram from 80 Gbps to 10 Gbps. It can be seen that a clear and open eye diagram may be obtained. A diagram 334 shows the eye diagram after transmission over 100 km TW fibers and DCF. Since there is about 10 ps/nm dispersion over-compensation, there may be some differences between the diagrams 330 and 334. For example, the signal in the diagram 330 can be seen to be sharper than that in the diagram 334.

A diagram 336 shows an RF spectrum of the recovered clock, indicating a super-mode noise suppression of as much as 60 dB. The rms (root-mean-square) timing jitter may be smaller than 150 femto seconds (fs).

Graph lines 322, 324, 326 and 328 of FIG. 5 illustrate log(BER) vs. optical power (dBm) for various different demultiplexing operations in an exemplary embodiment according to the present invention. The graph line 322 illustrates the case of demultiplexing 20 Gbps OTDM signal to 10 Gbps signals without transmission. The graph line 324 illustrates the case of demultiplexing 40 Gbps OTDM signal to 10 Gbps signals without transmission. The graphs lines 326 and 328 illustrate the case of demultiplexing 80 Gbps OTDM signals to 10 Gbps signals, respectively, before and after transmission over DCF and TW fibers.

It can be seen, for example, by comparing graphs 322 and 324 that when 40 Gbps OTDM signal is demultiplexed to 10 Gbps, the power penalty compared with 20 Gbps signal demultiplexed to 10 Gbps may be approximately 0.6 dB. The penalty may be caused by the adjacent crosstalk because of the imperfect switching window of TEAM. Further, it can be seen by comparing graphs 322 and 326 that when 80 Gbps OTDM signal is demultiplexed to 10 Gbps, the power penalty compared with 20 Gbps signal demultiplexed to 10 Gbps may be approximately 1.2 dB.

The 80 Gbps OTDM signal may also be transmitted over 100 km TW fibers and DCF, and a comparison between the graphs 326 and 328 show that the additional power penalty after transmission may be approximately 1.2 dB. The power penalty after transmission is typically caused by nonlinear effects, dispersion over-compensation and polarization mode dispersion.

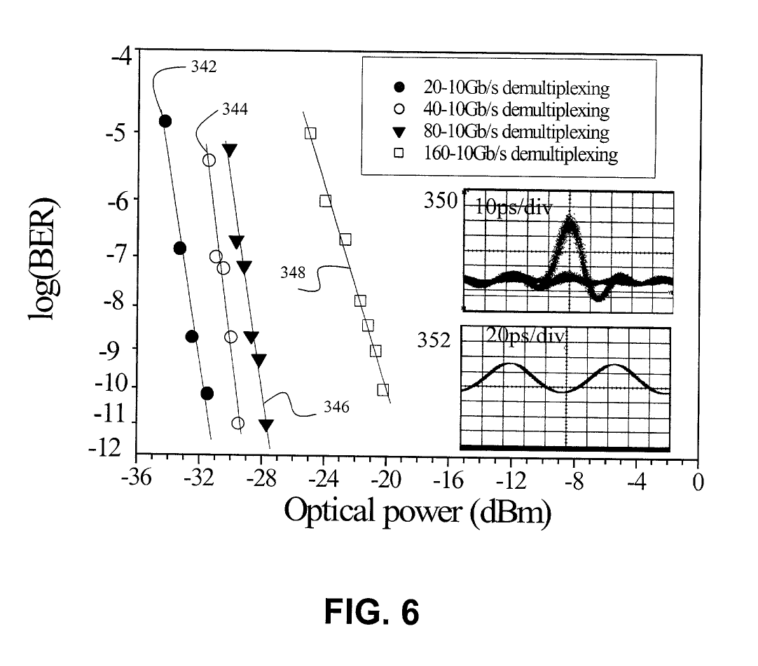

FIG. 6, for example, shows BER performance, a 10 Gbps eye diagram 350 demultiplexed from 160 Gbps without transmission, and a recovered electrical clock waveform 352. To show BER performance, graph lines 342, 344, 346 and 348 are illustrated. The graph line 342 illustrates the case of demultiplexing 20 Gbps OTDM signal to 10 Gbps signals without transmission. The graph line 344 illustrates the case of demultiplexing 40 Gbps OTDM signal to 10 Gbps signals without transmission. The graph line 346 illustrates the case of demultiplexing 80 Gbps OTDM signal to 10 Gbps signals without transmission. The graph line 348 illustrates the case of demultiplexing 160 Gbps OTDM signal to 10 Gbps signals without transmission.

It can be seen, for example, by comparing graphs 342 and 344 that when a 40 Gbps OTDM signal is demultiplexed to 10 Gbps signals, the power penalty compared with 20 Gbps signal demultiplexed to 10 Gbps signals may be approximately 1.8 dB. The penalty may be caused, for example, by the adjacent crosstalk because of the imperfect switching window of TEAM as shown in FIG. 4(b). In addition, it can be seen by comparing graphs 342 and 346 that when 80 Gbps OTDM signal is demultiplexed to 10 Gbps, the power penalty compared with 20 Gbps signal demultiplexed to 10 Gbps may be approximately 3.2 dB. Further, it can be seen by comparing graphs 342 and 348 that when 160 Gbps OTDM signal is demultiplexed to 10 Gbps signals, the power penalty compared with 20 Gbps signal demultiplexed to 10 Gbps may be approximately 11 dB. This penalty may be caused, for example, by the imperfect switching window and the limitation ER of transmission signal.

It should be noted that the TEAM used to generate graphs and diagrams of FIGS. 5 and 6 is designed for applications in a 40 Gbps RZ transmitter, and not for high-speed OTDM demultiplexing. In an exemplary embodiment, the TEAM for demultiplexing OTDM signal may have two narrow band EAMs in order to obtain a narrower switching window and reduced crosstalk from the adjacent channels.

According to an exemplary embodiment, a single TEAM can be used to perform demultiplexing and clock recovery from 160 Gbps OTDM signals. In other embodiments, the functions of clock recovery and demultiplexing may be implemented by two individual TEAMs in order to demultiplex a random channel from the OTDM signals. In still other embodiments, the optical receiver further comprises a clock storage device, and a single TEAM may be used to demultiplex a random channel and to perform clock recovery from 160 Gbps OTDM signals. The clock storage device may comprise a buffer for clock storage, and may be used to maintain frequency and phase of the clock.

In another exemplary embodiment according to the present invention, a fiber Raman amplifier may be used together with a TEAM to achieve simultaneous demultiplexing and clock recovery of an OTDM signal from a high speed (e.g., 160 Gbps) single channel un-repeated transmission over a long (e.g., 200 km) distance. The longest un-repeated transmission distance being used or contemplated may be 100 km TW fiber and 160 km single mode fiber.

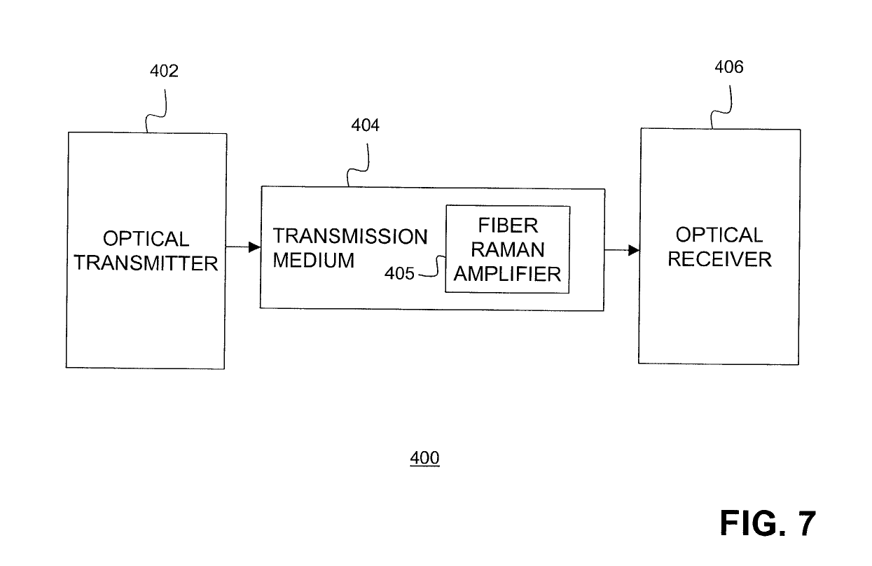

FIG. 7 is a block diagram of an optical communication system 400, which for example may be used to transmit 160 Gbps OTDM signal and to demultiplex the 160 Gbps OTDM signal to 10 Gbps signals at the receiver end. The optical communication system 400 is similar to the optical communication system 100 of FIG. 1 except that the optical communication system 400 includes a fiber Raman amplifier 405. The design and application of fiber Raman amplifiers are known to those skilled in the art. The optical communication system 400 also includes an optical transmitter 402, a transmission medium 104 and a TEAM-based optical receiver 406.

In the exemplary embodiment, the optical transmitter 402 may comprise two modulators, a two-fiber compressor and a regenerator. A 10 GHz train of 14 ps pulses at 1548.6 nm may be obtained by driving an EAM with a 10 GHz sinusoidal RF tone. The train of pulses may then be modulated by a 10 Gbps data stream using a LiNbO₃ modulator.

The modulated signals may then be compressed and regenerated by two fiber stages, each stage of which may contain one or more of a dispersion shifted fiber (DSF), a tunable optical filter (TOF), and a single mode fiber (SMF). The 3 dB bandwidth of the TOF in the second fiber stage, for example, may be 2 nano meter (nm). After the second stage compression and regeneration, the FWHM pulse width may be approximately 1.4 ps, the extinction ratio (ER) may be larger than 25 dB, and the time-bandwidth product may be 0.36. The compressed and regenerated signal may then be multiplexed by a multi-stage (e.g., four stage) fiber delay-line multiplexer to generate a 160 Gbps OTDM signal.

When the 160 Gbps OTDM signal is demultiplexed in the optical receiver 406 by a TEAM, a narrow switching window may be required. The 160 Gbps OTDM signal may first be demultiplexed to 40 Gbps signals by the first EAM in the TEAM, then the 40 Gbps signals may be demultiplexed to 10 Gbps signals by the second EAM in the TEAM. The bias current of the SOA in the TEAM may be maintained at 120 mA

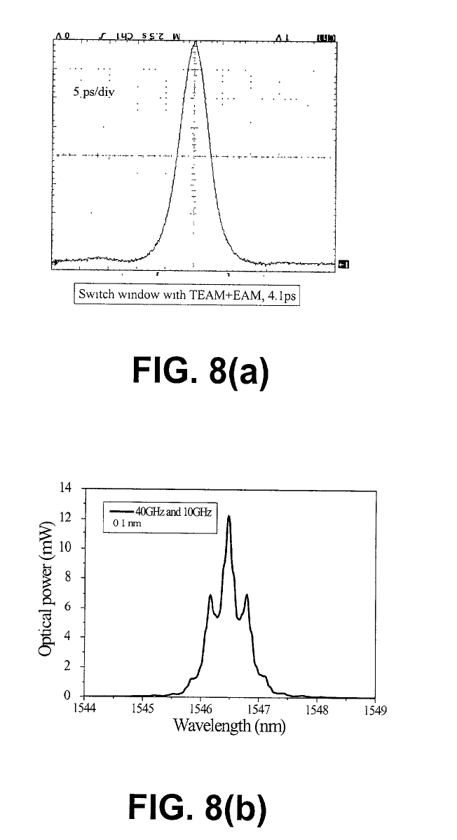

An auto-correlator may be used to measure the switching window of the TEAM. For example, FIGS. 8(a) and 8(b) may show the auto-correlator traces and optical spectrum, respectively, when the second EAM is driven by a 40 GHz sinusoidal wave with 6 Vₚₚ drive voltage and the first EAM is simultaneously driven by a 10 GHz sinusoidal wave with 9 Vₚₚ drive voltage. In this scenario, the switching window of the TEAM may be approximately 4.1 ps (FWHM) and the ER may be larger than 20 dB. The switching window of 4.1 ps may be narrow enough for demultiplexing the 160 Gbps OTDM signal. In the optical spectrum of FIG. 8(b), 3 dB bandwidth of the optical spectrum may be approximately 0.7 nm. The time-bandwidth product may be approximately 0.36, which is near the transform-limited product of sech² pulses.

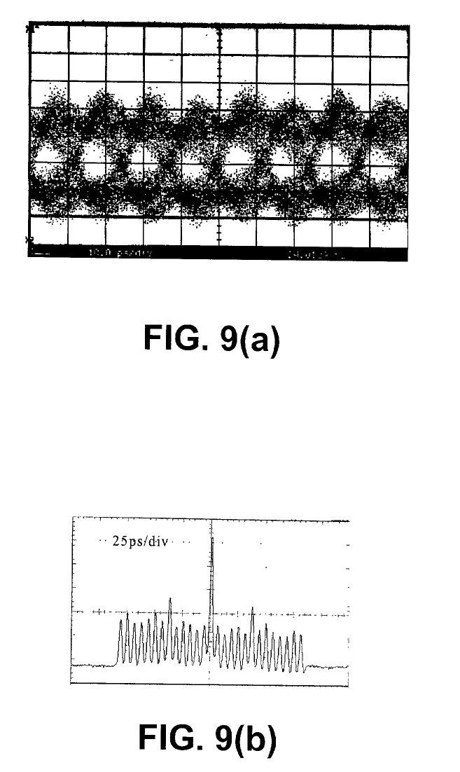

FIGS. 9(a) and 9(b) illustrate an eye diagram for a multiplexed 80 Gbps OTDM signal and an auto-correlator trace for a 160 Gbps OTDM signal, respectively. The eye diagram in FIG. 9(a) may show that different channels have the same amplitude. An eye diagram of the 160 Gbps OTDM signal would be similar to the eye diagram of the 80 Gbps OTDM signal when an oscilloscope with sufficiently high resolution is used. The uneven height of the auto-correlation peaks may be illustrative of a different polarization direction of the different channels of the OTDM signals because the multiplexer does not comprise polarization maintaining fibers. However, the multiplexed channels of 160 Gbps OTDM signals may have the same channel spacing of 6.25 ps.

A dispersion pre-compensation scheme may be used. The aggregated 160 Gbps OTDM signal may be transmitted over the DCF and the pulse may be broadened. Hence, the nonlinear effect may be reduced, and high input power into nonzero dispersion shifted fiber may be endured. The input power into first section of DCF, for example, may be 2.8 dBm, and the loss of this first section of DCF may be 12 dB. Then the signal may be amplified to 6 dBm and transmitted over another section of DCF, the loss of which section may be 8 dB.

The DCF may provide nearly full-dispersion compensation for the two nonlinear dispersion fiber spans. The OTDM signal may be amplified to 9 dBm average power by an EDFA, then it may be transmitted over 200 km non-zero dispersion shifted fiber. The fiber Raman amplifier in the transmission medium 404 may be used to support 15 dB gain in the non-zero dispersion shifted-wave fiber. The non-zero dispersion shift-wave fiber may have an average dispersion of 5.4 ps/nm/km at 1550 nm and dispersion slope of 0.037 ps/nm²/km. The total loss of non-zero dispersion fibers may be 43 dB. Polarization mode dispersion (PMD) measurements on the fiber spans may show PMD values of less than 0.07 ps/\sqrt{km}.

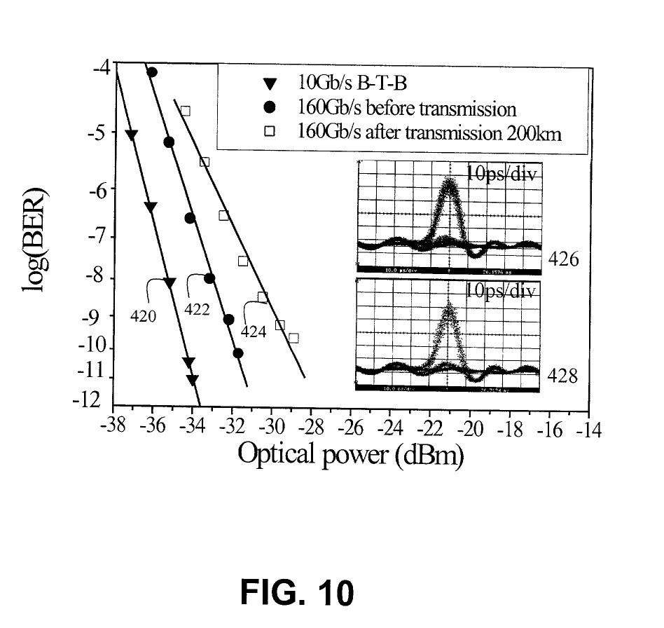

FIG. 10 shows BER performance and typical demultiplexed eye diagrams measured with a 50 GHz photodiode and a 50 GHz sampling oscilloscope. A diagram 426 illustrates a demultiplexed eye diagram from 160 Gbps to 10 Gbps signals prior to transmission. The penalty may be caused by the limited extinction ratio of the input 160 Gbps signal. A diagram 428 illustrates a demultiplexed eye diagram after transmission over DCF and 200 km non-linear dispersion fiber. A clear and open eye diagram may be obtained.

Graph lines 420, 422 and 424 illustrate a BER performance graph illustrating log(BER) vs. optical power (dBm). It can be seen, for example, by comparing the graph lines 420 and 422 that when the 160 Gbps OTDM signal is demultiplexed to 10 Gb/s, the power penalty at BER of 10⁻⁹ compared with back-to-back 10 Gbps signal may be approximately 2.5 dB. After the OTDM signal is transmitted over 200 km non-zero dispersion fiber and DCF, and the additional power penalty at BER of 10⁻⁹ after transmission may be approximately 2.2 dB. The power penalty after transmission may be caused, for example, by polarization mode dispersion.

Thus, with fiber Raman amplifier and dispersion pre-compensation, the 160 Gb/s signal un-repeated transmission over 200 km non-zero dispersion fiber may be demultiplexed with a penalty of 2.2 dB. In the optical receiver, a TEAM may be used for simultaneous demultiplexing and clock recovery of 160 Gbps OTDM signals, which may make the optical receiver of OTDM signals simpler and more stable. The switching window of TEAM may be very narrow at 4.1 ps.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by the appended claims and their equivalents.

What is claimed is:

1. An optical receiver comprising a single integrated device capable of performing demultiplexing and clock recovery of an optical time division multiplexed (OTDM) signal substantially simultaneously, wherein the OTDM signal has a speed higher than 40 Gbps.

2. The optical receiver according to claim 1, wherein the single integrated device comprises a tandem electro-absorption modulator (TEAM).

3. The optical receiver according to claim 2, wherein the TEAM comprises a semiconductor optical amplifier (SOA) interposed between at least two electro-absorption modulators.

4. The optical receiver according to claim 3, wherein the SOA is monolithically integrated with the electro-absorption modulators.

5. The optical receiver according to claim 1, further comprising a clock storage device capable of storing the recovered clock.

6. The optical receiver according to claim 3, further comprising a frequency adjuster for adjusting frequency of the recovered clock prior to providing the recovered clock to at least one of the electro-absorption modulators.

7. The optical receiver according to claim 3, wherein the electro-absorption modulators are narrow band modulators.

8. The optical receiver according to claim 3, wherein the TEAM further comprises at least one spot size converter for efficient optical coupling.

9. The optical receiver according to claim 3, wherein the TEAM comprises a thin separate confinement heterostructure multi-quantum well active layer.

10. An optical receiver for substantially simultaneously demultiplexing an optical time division multiplexed (OTDM) signal and recovering clock from the OTDM signal, the optical receiver comprising a first tandem electro-absorption modulator (TEAM) for demultiplexing the OTDM signal and a second TEAM for recovering clock from the OTDM signal.

11. The optical receiver according to claim 10, wherein each TEAM comprises a semiconductor optical amplifier (SOA) interposed between at least two electro-absorption modulators.

12. The optical receiver according to claim 11, wherein the SOA is monolithically integrated with the electro-absorption modulators.

13. The optical receiver according to claim 11, wherein the electro-absorption modulators in at least one TEAM comprise narrow band modulators.

14. The optical receiver according to claim 11, wherein at least one TEAM further comprises at least one spot size converter for efficient optical coupling.

15. An optical communication system comprising:
a transmitter for generating and transmitting an optical time division multiplexed (OTDM) signal;
a transmission medium suitable for carrying the OTDM signal; and
a receiver for receiving the OTDM signal, said receiver comprising one or more tandem electro-absorption modulators (TEAMs), and said receiver being capable of substantially simultaneously performing demultiplexing and clock recovery of the OTDM signal using said one or more TEAMs.

16. The optical communication system according to claim 15, wherein the receiver comprises one TEAM for performing both demultiplexing and clock recovery of the OTDM signal.

17. The optical communication system according to claim 15, wherein the receiver comprises at least two TEAMs, at least one TEAM for demultiplexing and at least one other TEAM for clock recovery.

18. The optical communication system according to claim 15, wherein each TEAM comprises a semiconductor optical amplifier (SOA) interposed between at least two electro-absorption modulators.

19. The optical communication system according to claim 18, wherein the electro-absorption modulators comprise narrow band modulators.

20. The optical communication system according to claim 18, wherein each TEAM further comprises at least one spot size converter for efficient optical coupling.

21. The optical communication system according to claim 15, further comprising a fiber Raman amplifier to boost an intensity of the OTDM signal.
